(19) United States
(12) Patent Application Publication
(10) Pub. No.: US 2026/0257303 A1
(43) Pub. Date: Sep. 3, 2026

(54) AUTOMATED INLINE WELD PARAMETER ADJUSTMENT

(71) Applicant: GM Global Technology Operations LLC, Detroit, MI (US)

(72) Inventors: Ahmad Almarkhi, Farmington Hills, MI (US); Hassan Ghassemi-Armaki, Northville, MI (US); Blair E. Carlson, Ann Arbor, MI (US); John Patrick Spicer, Plymouth, MI (US); Joseph Williams, Washington Twp, MI (US); Jeffrey A. Abell, Rochester Hills, MI (US)

(21) Appl. No.: 19/068,573

(22) Filed: Mar. 3, 2025

(51) Int. Cl. B23K 31/12; B23K 101/00

(52) U.S. Cl. CPC B23K 31/125; B23K 2101/006

(57) ABSTRACT

A system for detecting negative trends in discrepant weld occurrence and automatically adjusting weld parameters includes a system controller in communication with a weld controller of a manufacturing line for vehicle components, the system controller adapted to monitor, with a weld monitoring system a plurality of welds on each one of a plurality of vehicle components, collect data related to each one of the plurality of welds on each one of the plurality of vehicle components, analyze, with a plurality of algorithms using deep learning techniques, the data related to each one of the plurality of welds on each one of the plurality of vehicle components, identify, for each of the plurality of welds, negative trends associated with occurrence of discrepant welds, and automatically, via communication with the weld controller, adjust weld parameters for at least one of the plurality of welds.

### INTRODUCTION

The present invention relates generally to detecting negative trends in the occurrence of discrepant welds in a welding process and automatically adjusting weld parameters to counter detected negative trends.

Weld monitoring systems can assess the quality of body spot welds individually and detect non-preferred discrepant welds, including so called “edge-welds”. The weld quality is crucial for structural integrity of the vehicle as well as the paint and corrosion behavior. There are several root causes for edge welds, but there may be inconsistencies between different batches of parts. Problems with current systems and methods include the inability to predict discrepant welds ahead of time, current systems and methods rely on visual inspection and manual intervention slows the process and involves added labor to adjust weld parameters, and adjusting weld parameters manually can cause shifts that may result in even larger failure rates.

Thus, while current systems and methods achieve their intended purpose, there is a need for a new and improved system and method for automatically detecting negative trends and automatically adjusting weld parameters to avoid discrepant welds.

### SUMMARY

According to several aspects of the present disclosure, a system for detecting negative trends in discrepant weld occurrence and automatically adjusting weld parameters includes a system controller in communication with a weld controller of a manufacturing line for vehicle components, the system controller adapted to monitor, with a weld monitoring system in communication with the system controller, a plurality of welds on each one of a plurality of vehicle components as the plurality of vehicle components move along the manufacturing line, collect, via the weld monitoring system, data related to each one of the plurality of welds on each one of the plurality of vehicle components, analyze, with a plurality of algorithms using deep learning techniques, the data related to each one of the plurality of welds on each one of the plurality of vehicle components, identify, for each of the plurality of welds, negative trends associated with occurrence of discrepant welds, and automatically, via communication with the weld controller, adjust weld parameters for at least one of the plurality of welds.

According to another aspect, when collecting, via the weld monitoring system, data related to each of the plurality of welds on each one of the plurality of vehicle components, the system controller is further adapted to collect, with sensors positioned on welding sub-systems and associated with the weld monitoring system, data related to each of the plurality of welds on each one of the plurality of vehicle components, and collect, with external sensors associated with the weld monitoring system, data related to each of the plurality of welds on each one of the plurality of vehicle components.

According to another aspect, when collecting, via the weld monitoring system, data related to each of the plurality of welds on each one of the plurality of vehicle components, the system controller is further adapted to collect data including, but not limited to, weld location, weld schedule and variables associated therewith, a weld identification (ID), vehicle information, and sensor-based inspection data.

According to another aspect, when collecting data including, but not limited to, weld location, weld schedule and variables associated therewith, a weld identification (ID), vehicle information, and sensor-based inspection data, the weld monitoring system is further adapted to communicate with and receive information from at least one of a human machine interface (HMI) adapted to allow manual entry of data by a human operator, a radio frequency identification (RFID) reader adapted to read data from an RFID tag positioned on each one of the vehicle components, and a vision camera adapted to read data from a two-dimensional matrix positioned on each one of the vehicle components.

According to another aspect, when collecting, via the weld monitoring system, data related to each of the plurality of welds on each one of the plurality of vehicle components, the system controller is further adapted to collect data for the weld from a database based on the weld ID.

According to another aspect, when analyzing the data related to each one of the plurality of welds on each one of the plurality of vehicle components, the system controller is further adapted to detect discrepant welds and assign a quality measure for each detected discrepant weld, and match the weld ID and associated weld parameters with computer aided design (CAD) models.

According to another aspect, when identifying, for each of the plurality of welds, negative trends associated with occurrence of discrepant welds, the system controller is adapted to identify the occurrence of, for any one of the plurality of welds, a number of discrepant welds within a sample set that exceeds a pre-determined threshold, and identify a trend, wherein, for any one of the plurality of welds, a number of discrepant welds within a sample set is increasing, and identify a trend, wherein, for any one of the plurality of welds, a quality measure of the identified discrepant welds is deteriorating.

According to another aspect, when automatically adjusting weld parameters for at least one of the plurality of welds, the system controller is further adapted to adjust weld parameters including, but not limited to, location and orientation of a weld gun of a weld assembly associated with the at least one of the plurality of welds, a weld schedule for the at least one of the plurality of welds and internal logic algorithms within the weld controller.

According to another aspect, after automatic adjustments have been made to the weld parameters for at least one of the plurality of welds, the system controller is further adapted to collect, via the weld monitoring system, data related to the at least one of the plurality of welds for which adjustments were made, analyze, with a plurality of algorithms using deep learning techniques, the data related to the at least one of the plurality of welds for which adjustments were made, and determine if the automatic adjustments corrected the identified negative trends.

According to another aspect, when the system controller determines that the automatic adjustments did not correct the identified negative trends, the system controller is adapted to repeatedly, until identified negative trends have been corrected, collect, via the weld monitoring system, data related to each one of the plurality of welds on each one of the plurality of vehicle components, analyze, with the plurality of algorithms using deep learning techniques, the data related to each one of the plurality of welds on each one of the plurality of vehicle components, identify, for each of the plurality of welds, negative trends associated with occurrence of discrepant welds, and automatically, via communication with the weld controller, adjust weld parameters for at least one of the plurality of welds.

According to several aspects of the present disclosure, a method for detecting negative trends in discrepant weld occurrence and automatically adjusting weld parameters, includes, with a system controller in communication with a weld controller of a manufacturing line for vehicle components, monitoring, with a weld monitoring system in communication with the system controller, a plurality of welds on each one of a plurality of vehicle components as the plurality of vehicle components move along the manufacturing line, collecting, via the weld monitoring system, data related to each one of the plurality of welds on each one of the plurality of vehicle components, analyzing, with a plurality of algorithms using deep learning techniques, the data related to each one of the plurality of welds on each one of the plurality of vehicle components, identifying, for each of the plurality of welds, negative trends associated with occurrence of discrepant welds, and automatically, via communication with the weld controller, adjusting weld parameters for at least one of the plurality of welds.

According to another aspect, the collecting, via the weld monitoring system, data related to each of the plurality of welds on each one of the plurality of vehicle components further includes collecting, with sensors positioned on welding sub-systems and associated with the weld monitoring system, data related to each of the plurality of welds on each one of the plurality of vehicle components, and collecting, with external sensors associated with the weld monitoring system, data related to each of the plurality of welds on each one of the plurality of vehicle components.

According to another aspect, the collecting, via the weld monitoring system, data related to each of the plurality of welds on each one of the plurality of vehicle components further includes collecting data including, but not limited to, weld location, weld schedule and variables associated therewith, a weld identification (ID), vehicle information, and sensor-based inspection data by at least one of communicating and receiving data from a human machine interface (HMI) adapted to allow manual entry of data by a human operator, communicating and receiving data from a radio frequency identification (RFID) reader adapted to read data from an RFID tag positioned on each one of the vehicle components, and communicating and receiving data from a vision camera adapted to read data from a two-dimensional matrix positioned on each one of the vehicle components.

According to another aspect, the collecting, via the weld monitoring system, data related to each of the plurality of welds on each one of the plurality of vehicle components, further includes communicating and receiving data from a database adapted to store information related to the vehicle body components being welded and the plurality of welds to be applied thereon based on the weld ID.

According to another aspect, the analyzing the data related to each one of the plurality of welds on each one of the plurality of vehicle components further includes detecting discrepant welds, assigning a quality measure for each detected discrepant weld, and matching the weld ID and associated weld parameters with computer aided design (CAD) models.

According to another aspect, the identifying, for each of the plurality of welds, negative trends associated with occurrence of discrepant welds further includes identifying the occurrence of, for any one of the plurality of welds, a number of discrepant welds within a sample set that exceeds a pre-determined threshold, and identifying a trend, wherein, for any one of the plurality of welds, a number of discrepant welds within a sample set is increasing, and identifying a trend, wherein, for any one of the plurality of welds, a quality measure of the identified discrepant welds is deteriorating.

According to another aspect, the automatically adjusting weld parameters for at least one of the plurality of welds further includes adjusting weld parameters including, but not limited to, location and orientation of a weld gun of a weld assembly associated with the at least one of the plurality of welds, a weld schedule for the at least one of the plurality of welds and internal logic algorithms within the weld controller.

According to another aspect, after automatically adjusting weld parameters for at least one of the plurality of welds, the method further includes collecting, via the weld monitoring system, data related to the at least one of the plurality of welds for which adjustments were made, analyzing, with a plurality of algorithms using deep learning techniques, the data related to the at least one of the plurality of welds for which adjustments were made, and determining if the automatic adjustments corrected the identified negative trends.

According to another aspect, when the system controller determines that the automatic adjustments did not correct the identified negative trends, the method includes, repeatedly, with the system controller, until identified negative trends have been corrected, collecting, via the weld monitoring system, data related to each one of the plurality of welds on each one of the plurality of vehicle body components, analyzing, with the plurality of algorithms using deep learning techniques, the data related to each one of the plurality of welds on each one of the plurality of vehicle components, identifying, for each of the plurality of welds, negative trends associated with occurrence of discrepant welds, and automatically, via communication with the weld controller, adjusting weld parameters for at least one of the plurality of welds.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic view of a manufacturing line having a system according to an exemplary embodiment of the present disclosure;

FIG. 2 is a schematic diagram of the system according to an exemplary embodiment;

FIG. 3 is a perspective view of a sample vehicle component having two discrepant welds and one non-discrepant weld thereon; and

FIG. 4 is a schematic flow chart illustrating a method according to an exemplary embodiment of the present disclosure;

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges.

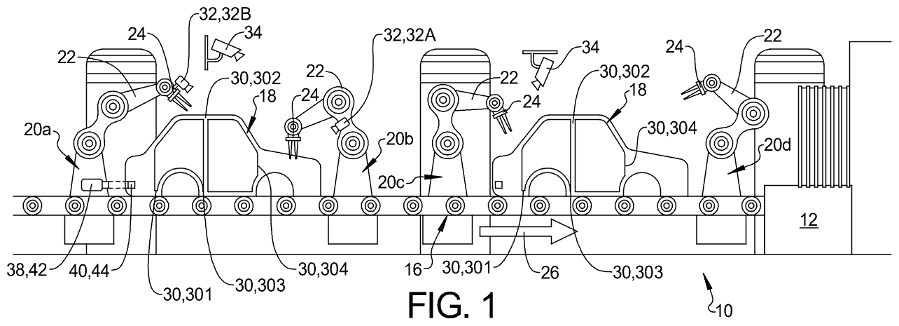

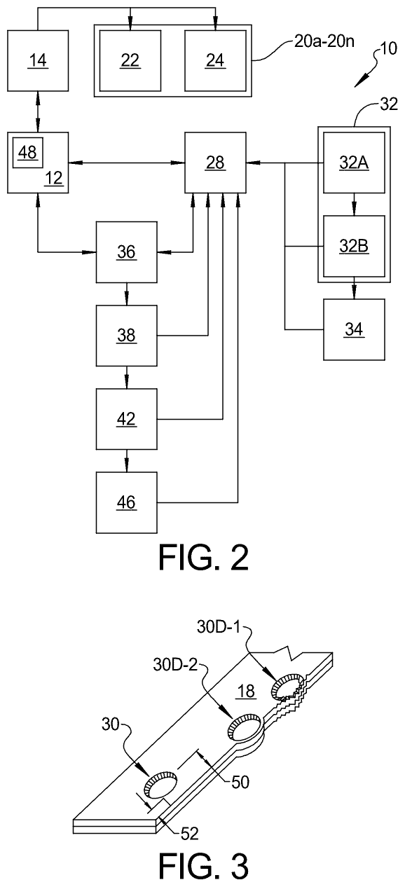

Example embodiments will now be described more fully with reference to the accompanying drawings. Referring to FIG. 1 and FIG. 2, a system 10 for detecting negative trends in discrepant weld occurrence and automatically adjusting weld parameters in accordance with an exemplary embodiment of the present disclosure includes a system controller 12 in communication with a weld controller 14 of a manufacturing line 16 for vehicle components 18.

By way of non-limiting example, as shown in FIG. 1 and FIG. 2, the manufacturing line 16 is adapted to apply welds to vehicle components 18, wherein the vehicle components 18 are vehicle body structures. The manufacturing line 16 transports a plurality of vehicle components 18, sequentially, within operational proximity of a plurality of welding assemblies 20a-20n, wherein each welding assembly 20a-20n includes a robotic articulating arm 22 that supports a welding gun 24 thereon. As shown, the manufacturing line 16 transports the vehicle components 18, as indicated by arrow 26, to a first welding assembly 20a, a second welding assembly 20b, a third welding assembly 20c and a fourth welding assembly 20d. It should be understood by those skilled in the art that the system 10 may include any number of welding assemblies 20a-20n without departing from the scope of the present disclosure. Each welding assembly 20a-20n, under the control of the system controller 12 and the weld controller 14 is adapted to apply at least one weld to each vehicle component 18. Depending on cycle time and location, any one of the plurality of welding assemblies 20a-20n may be adapted to apply multiple welds onto each vehicle component 18.

The system controller 12 and the weld controller 14 are non-generalized, electronic control devices having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

The system controller 12 is in communication with a weld monitoring system 28, wherein the system controller 12, using the weld monitoring system 28 monitors a plurality of welds 30 on each one of the plurality of vehicle components 18 as the plurality of vehicle components 18 move along the manufacturing line 16.

The weld monitoring system 28 may be of a type commonly known and used in the industry. Non-contact and non-destructive automated welding inspection systems improve quality control processes by eliminating manual weld inspections that are prone to inspector error and subjectivity. The weld monitoring system compares weld characteristics against a predetermined quality standard based on the intended use and/or industry. In an exemplary embodiment, real-time weld dimensional data generated by high resolution 3D vision sensors is analyzed for defects by software that features algorithms and deep learning techniques. Components of the weld monitoring system 28 can be integrated into the welding assemblies 20a-20n to track weld performance in real-time and/or the weld monitoring system 28 can operate after welding of the vehicle component 18 is complete. In some instances, sensors and cameras of the weld monitoring system 28 can be positioned on the robotic articulating arms 22 of the welding assemblies 20a-20n, so the robotic articulating arms 22 can be used to maneuver and position such sensors and cameras. The weld monitoring system 28 can check the geometry of each weld 30, including the weld length, shape, volume and weld alignment. Further, the weld monitoring system 28 can detect defects in the welds 30 that may occur, such as spatter, burn-through, undercutting, porosity and discrepant edge welds.

The system controller 12 is adapted to collect, with the weld monitoring system 28, data related to each one of the plurality of welds 30 on each one of the plurality of vehicle components 18. In an exemplary embodiment, when collecting, via the weld monitoring system 28, data related to each of the plurality of welds 30 on each one of the plurality of vehicle components 10, the system controller 12 is further adapted to collect, with sensors 32 positioned on welding sub-systems such as the robotic articulating arms 22 and the welding guns 24 of the welding assemblies 20a-20n, and associated with the weld monitoring system 28, data related to each of the plurality of welds 30 on each one of the plurality of vehicle components 18, and further, collect, with external sensors 34 associated with the weld monitoring system 28, data related to each of the plurality of welds 30 on each one of the plurality of vehicle components 18. The data includes, but is not limited to, weld location, weld schedule and variables associated therewith, a weld identification (ID), vehicle information, and sensor-based inspection data.

The sensors 32 positioned on welding sub-systems and the external sensors 34 may be cameras, adapted to visually “look” at the welds 30 as the welds 30 are being formed and after the welds 30 are formed. The sensors 32 positioned on welding sub-systems may include sensors mounted onto the weld gun 24 adapted to monitor the performance of the weld gun 24 (voltage, temperature, etc.) as a measure of the quality of the welds 30. As shown in FIG. 1, a sensor 32A is positioned on the robotic articulating arm 22 of the second welding assembly 20b, and adapted to monitor the weld being formed by the weld gun 24 mounted onto the robotic articulating arm 22 of the second welding assembly 20b. Further, a sensor 32B is positioned on the weld gun 24 of the first welding assembly 20a. External sensors 34 are mounted in proximity to the welding assemblies 20a-20n and able to collect data and monitor the welds 30 formed by the plurality of weld assemblies 20a-20n.

In an exemplary embodiment, the system controller 12, via the weld monitoring system 28, when collecting data related to the welds 30, is further adapted to communicate with and receive information from at least one of a human machine interface (HMI) 36 adapted to allow manual entry of data by a human operator and to allow information to be shared by the system controller 12 with an operator of the system 10, a radio frequency identification (RFID) reader 38 adapted to read data from an RFID tag 40 positioned on each one of the vehicle components 18, and a vision camera 42 adapted to read data from a two-dimensional matrix 44 positioned on each one of the vehicle components 18. As shown in FIG. 1, a generic camera mounted onto the first welding assembly 20a may be either an RFID reader 38 or a vision camera 42, and a label attached to the vehicle component 18 may be either an RFID tag 40 or a two-dimensional matrix 44. It should be understood by those skilled in the art that the system 10 may receive data related to the welds 30, such as the weld ID or specific parameters associated with the welds 30, from any one of or any combination of the HMI 36, the RFID reader 38 or the visual camera 42.

In an exemplary embodiment, the system controller 12, via the weld monitoring system 14, collects data for the weld 30 from a database 46 based on the weld ID. For example, once the system controller 12 knows the weld ID for the weld 30, as obtained from the HMI 36, RFID tag 40 or two-dimensional matrix 44 attached to the vehicle component 18, the system controller 12 can access the database 46 that includes detailed data such as weld parameters, dimensional and locational parameters and other data stored within the database 46 and associated with the weld ID. Thus, using the weld ID, the system controller 12 can obtain access to much more data related to each of the plurality of welds 30 on each of the vehicle components 18. Each weld 30 on each of the vehicle components 18 has a unique weld ID. Specifications and parameters for each weld 30 will be based on performance requirements for the weld 30. The database 46 may be located within the system controller 12, or may be a remote database that is directly or wirelessly in communication with the system controller 12 or weld monitoring system 28.

Using data that is collected or received by the weld monitoring system 28, the system controller 12 is adapted to analyze, with a plurality of algorithms 48 stored therein, using deep learning techniques, the data related to each one of the plurality of welds 30 on each one of the plurality of vehicle components 18. The system controller 12 is further adapted to detect discrepant welds 30D and assign a quality measure for each detected discrepant weld 30D, and match the weld ID and associated weld parameters for each weld 30 with computer aided design (CAD) models stored within the system controller 12, or stored within the database 46.

Referring to FIG. 3, an edge weld is a weld formed at or near an edge of the vehicle component 18. An edge weld 30 has weld parameters, such as centerline distance 50 from the edge of the component 18 and nominal distance 52 from the edge of the component 18 to insure proper quality and structural integrity of the weld 30. A discrepant weld 30D is a weld that does not satisfy these parameters. For example, as shown in FIG. 3, the acceptable edge weld 30 has proper location such that the centerline distance 50 and the nominal distance 52 satisfy the parameters for the edge weld 30. The values for and relationship between the centerline distance 50 and nominal distance 52 are dependent upon many factors, including, but not limited to the size of the electrode of the weld gun 24, the material that the vehicle component 18 is made from and the structural strength requirements for the vehicle component 18.

A discrepant edge weld 30D is a weld that does not meet one or more of the weld parameters. For example, referring again to FIG. 3, the top weld 30D-1 is an example of a discrepant edge weld with expulsion, wherein the weld has actually blown out the edge of the vehicle component 18. The middle weld 30D-2 is an example of a discrepant edge weld wherein the edge is bulging due to the weld 30D-2 not being properly spaced therefrom.

The system controller 12 is further adapted to assign a quality measure for each detected discrepant weld 30D. By evaluating the extent to which an identified discrepant weld fails to meet the weld parameters for that weld 30, and comparing the discrepant weld to CAD models of a proper weld 30 and modeling the sensors 32, 34, the system controller 12 establishes, for each identified discrepant weld, a quality measure.

The system controller 12 is further adapted to identify, for each of the plurality of welds 30, negative trends associated with occurrence of discrepant welds by identifying the occurrence of, for any one of the plurality of welds 30, a number of discrepant welds within a sample set that exceeds a pre-determined threshold. For example, during a production run, sample sets of ten vehicle components are taken periodically, wherein each of four welds 301, 302, 303, 304 are evaluated. The pre-determined threshold is, by way of illustrative example, three, wherein as long as three or less discrepant welds are identified in a sample set of ten vehicle components, then the system proceeds without adjustment.

During a first sample set, the system controller 12 identifies two of ten vehicle components where a first weld 301 is discrepant, zero of ten vehicle components where a second weld 302 is discrepant, one of ten vehicle components where a third weld 303 is discrepant, and one of ten vehicle components where a fourth weld 304 is discrepant. After the first sample set, the system controller takes no corrective action.

Later during the production run, during a second sample set, the system controller 12 identifies two of ten vehicle components where the first weld 301 is discrepant, zero of ten vehicle components where the second weld 302 is discrepant, four of ten vehicle components where the third weld 303 is discrepant, and one of ten vehicle components where the fourth weld 304 is discrepant. The number of times, within the sample set of ten vehicle components, that the third weld 303 was identified as discrepant exceeds the pre-determined threshold of three, and therefore, the system controller 12 will automatically, via communication with the weld controller 14, adjust weld parameters for the third weld 303.

The system controller 12 is further adapted to identify, for each of the plurality of welds 30, negative trends associated with occurrence of discrepant welds by identifying a trend, wherein, for any one of the plurality of welds 301, 302, 303, 304, a number of discrepant welds within a sample set is increasing. For example, during a production run, sample sets of ten vehicle components are taken periodically, wherein each of the four welds 301, 302, 303, 304 are evaluated. The pre-determined threshold is three discrepant welds.

During a first sample set, the system controller 12 identifies two of ten vehicle components where the first weld 301 is discrepant, zero of ten vehicle components where the second weld 302 is discrepant, one of ten vehicle components where the third weld 303 is discrepant, and one of ten vehicle components where the fourth weld 304 is discrepant.

Later, during a second sample set, the system controller 12 identifies two of ten vehicle components where the first weld 301 is discrepant, one of ten vehicle components where the second weld 302 is discrepant, one of ten vehicle components where the third weld 303 is discrepant, and one of ten vehicle components where the fourth weld 304 is discrepant.

Later, during a third sample set, the system controller 12 identifies two of ten vehicle components where the first weld 301 is discrepant, two of ten vehicle components where the second weld 302 is discrepant, one of ten vehicle components where the third weld 303 is discrepant, and one of ten vehicle components where the fourth weld 304 is discrepant.

Finally, during a fourth sample set, the system controller 12 identifies two of ten vehicle components where the first weld 301 is discrepant, three of ten vehicle components where the second weld 302 is discrepant, one of ten vehicle components where the third weld 303 is discrepant, and one of ten vehicle components where the fourth weld 304 is discrepant.

Even though, none of the welds 301, 302, 303, 304 has displayed a number if discrepant welds that exceeds the pre-determined threshold, the second weld 302 has shown a consistent trend of the number of discrepant welds increasing (going up by one each successive sample set). This indicates a trend that the system controller 12 identifies and uses to predict increased discrepant welds for the second weld 302, and can pre-emptively and automatically, via communication with the weld controller 14, adjust weld parameters for the second weld 302.

The system controller 12 is further adapted to identify, for each of the plurality of welds 30, negative trends associated with occurrence of discrepant welds by identifying a trend, wherein, for any one of the plurality of welds 301, 302, 303, 304, a quality measure of the identified discrepant welds is deteriorating. For example, during a production run, sample sets of ten vehicle components are taken periodically, wherein each of the four welds 301, 302, 303, 304 are evaluated. The pre-determined threshold is three discrepant welds.

During a first sample set, the system controller 12 identifies two of ten vehicle components where the first weld 301 is discrepant, zero of ten vehicle components where the second weld 302 is discrepant, one of ten vehicle components where the third weld 303 is discrepant, and one of ten vehicle components where the fourth weld 304 is discrepant. The quality measure assigned to each of the discrepant welds for the first, third and fourth welds 301, 303, 304 indicates the welds are only slightly out of compliance with weld parameters.

Later, during a second sample set, the system controller 12 identifies two of ten vehicle components where the first weld 301 is discrepant, one of ten vehicle components where the second weld 302 is discrepant, two of ten vehicle components where the third weld 303 is discrepant, and two of ten vehicle components where the fourth weld 304 is discrepant. The quality measure assigned to each of the discrepant welds for the first, third and fourth welds 301, 303, 304 indicates the welds are still only slightly out of compliance with weld parameters, however, the quality measure assigned to the discrepant weld for the second weld 302 indicates that the discrepant second weld 302 was substantially out of compliance with weld parameters.

Later, during a third sample set, the system controller 12 identifies two of ten vehicle components where the first weld 301 is discrepant, two of ten vehicle components where the second weld 302 is discrepant, one of ten vehicle components where the third weld 303 is discrepant, and one of ten vehicle components where the fourth weld 304 is discrepant. Once again, the quality measure assigned to each of the discrepant welds for the first, third and fourth welds 301, 303, 304 indicates the welds are still only slightly out of compliance with weld parameters, however, the quality measure assigned to the discrepant welds for the second weld 302 indicate that the discrepant second welds 302 are dramatically out of compliance with weld parameters.

The deteriorating quality measure of the discrepant welds for the second weld 302 is an indication that, while the pre-determined threshold is not exceeded, the quality of the second welds 302 is deteriorating, which may be an early indicator that more of the second welds 302 will be discrepant going forward, allowing the system controller 12 to pre-emptively and automatically, via communication with the weld controller 14, adjust weld parameters for the second weld 302.

Thus, by identifying negative trends, the system controller 12 can automatically make adjustments to the weld parameters including, but not limited to, location and orientation of the weld gun 24 of the weld assembly 20a-20n associated with the at least one of the plurality of welds 301, 302, 303, 304 for which the trend has been identified, a weld schedule for the at least one of the plurality of welds 301, 302, 303, 304 for which the trend has been identified and internal logic algorithms within the weld controller 14 that control movements of the robotic articulating arms 22 and weld guns 24 of the weld assemblies 20a-20n.

The system controller 12 will determine and calculate adjustments to the parameters based on analysis of the collected data, how the quality measures have trended, and determine proper location of a weld, taking into account the size of the electrode of the weld gun 24 and the nominal placement of the weld relative to the edge of the vehicle component 18. For example, with an electrode diameter of eight millimeters (mm), wherein the nominal weld location is five mm from the edge of the vehicle component 18, the weld monitoring system 28 provides either an exact location of the weld center using a vision camera, or, provides a classification window using modeling if sensors 32, 34. Thus, the minimum adjustment must be 8mm/2+5 mm=9 mm.

The system controller 12 will make adjustments to the weld parameters individually and independently for each weld assembly 20a-20n, adjusting placement of the weld 30, power to the weld gun 24, orientation of the weld gun 24 to the vehicle component 18 during welding, the overall weld schedule (order of welding, which welding assembly 20a-20n applies which one of the plurality of welds 301, 301, 303, 304), etc. to adjust each one of the resulting plurality of welds 301, 302, 303, 304, matching each one of the plurality of welds 301, 302, 303, 304 to CAD models that are either stored within the system controller 12, stored within the database 46, or accessed from a remote location wirelessly, to increase the overall quality of the welding process for the vehicle component 18.

After such adjustments are made, the system controller is adapted to verify that the adjustments did, in fact, improve the quality of the plurality of welds 30. The system controller 12, after automatic adjustments have been made to the weld parameters for at least one of the plurality of welds 30, is adapted to collect, via the weld monitoring system 28, data related to the at least one of the plurality of welds 301, 302, 303, 304 for which adjustments were made, analyze, with the plurality of algorithms 48 using deep learning techniques, the data related to the at least one of the plurality of welds 301, 302, 303, 3304 for which adjustments were made, and determine if the automatic adjustments corrected the identified negative trends.

The system controller looks at sequential sample sets, as described above, to determine if the negative trends originally identified by the system controller 12 have been corrected, have been improved, or if the adjustments did not have any affect at all.

If, the system controller 12 determines that the automatic adjustments did not correct the identified negative trends, the system controller 12 is adapted to repeatedly, until identified negative trends have been corrected, collect, via the weld monitoring system 28, data related to each one of the plurality of welds 301, 302, 303, 304 on each one of the plurality of vehicle components 18, analyze, with the plurality of algorithms 48 using deep learning techniques, the data related to each one of the plurality of welds 301, 302, 303, 304 on each one of the plurality of vehicle components 18, identify, for each of the plurality of welds 301, 302, 303, 304, negative trends associated with occurrence of discrepant welds, and automatically, via communication with the weld controller 14, adjust weld parameters for at least one of the plurality of welds 301, 302, 303, 304.

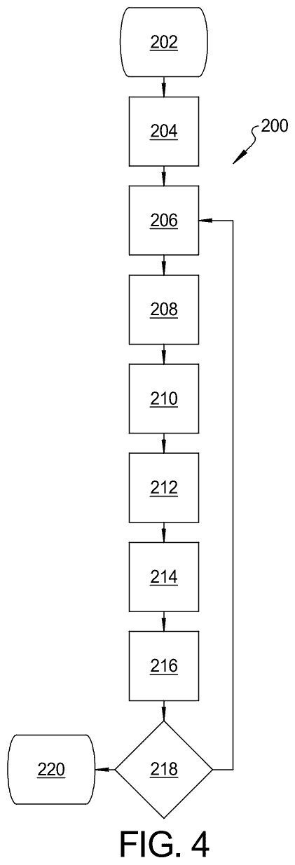

Referring to FIG. 4, a method 200 for detecting negative trends in discrepant weld occurrence and automatically adjusting weld parameters, includes, beginning at block 202, with a system controller 12 in communication with a weld controller 14 of a manufacturing line 16 for vehicle components 18, moving to block 204, monitoring, with a weld monitoring system 28 in communication with the system controller 12, a plurality of welds 30 on each one of a plurality of vehicle components 18 as the plurality of vehicle components 18 move along the manufacturing line 16, moving to block 206, collecting, via the weld monitoring system 28, data related to each one of the plurality of welds 30 on each one of the plurality of vehicle components 18, moving to block 208, analyzing, with a plurality of algorithms 48 using deep learning techniques, the data related to each one of the plurality of welds 30 on each one of the plurality of vehicle components 18, moving to block 210, identifying, for each of the plurality of welds 30, negative trends associated with occurrence of discrepant welds, and, moving to block 212, automatically, via communication with the weld controller 14, adjusting weld parameters for at least one of the plurality of welds 30.

In an exemplary embodiment, the collecting, via the weld monitoring system 28, data related to each of the plurality of welds 30 on each one of the plurality of vehicle components 18 at block 206 further includes collecting, with sensors 32 positioned on welding sub-systems and associated with the weld monitoring system 28, data related to each of the plurality of welds 30 on each one of the plurality of vehicle components 18, and collecting, with external sensors 34 associated with the weld monitoring system 28, data related to each of the plurality of welds 30 on each one of the plurality of vehicle components 18.

In another exemplary embodiment, the collecting, via the weld monitoring system 28, data related to each of the plurality of welds 30 on each one of the plurality of vehicle components 18 at block 206 further includes collecting data including, but not limited to, weld location, weld schedule and variables associated therewith, a weld identification (ID), vehicle information, and sensor-based inspection data by at least one of communicating and receiving data from a human machine interface (HMI) 36 adapted to allow manual entry of data by a human operator, communicating and receiving data from a radio frequency identification (RFID) reader 38 adapted to read data from an RFID tag 40 positioned on each one of the vehicle components 18, and communicating and receiving data from a vision camera 42 adapted to read data from a two-dimensional matrix 44 positioned on each one of the vehicle components 18.

In another exemplary embodiment, the collecting, via the weld monitoring system 28, data related to each of the plurality of welds 30 on each one of the plurality of vehicle components 18 at block 206, further includes communicating and receiving data from a database 46 adapted to store information related to the vehicle body components 18 being welded and the plurality of welds 30 to be applied thereon based on the weld ID.

In another exemplary embodiment, the analyzing the data related to each one of the plurality of welds 30 on each one of the plurality of vehicle components 18 at block 208 further includes detecting discrepant welds, assigning a quality measure for each detected discrepant weld, and matching the weld ID and associated weld parameters with computer aided design (CAD) models.

In another exemplary embodiment, the identifying, for each of the plurality of welds 30, negative trends associated with occurrence of discrepant welds at block 210 further includes identifying the occurrence of, for any one of the plurality of welds 30, a number of discrepant welds within a sample set that exceeds a pre-determined threshold, and identifying a trend, wherein, for any one of the plurality of welds 30, a number of discrepant welds within a sample set is increasing, and identifying a trend, wherein, for any one of the plurality of welds 30, a quality measure of the identified discrepant welds is deteriorating.

In another exemplary embodiment, the automatically adjusting weld parameters for at least one of the plurality of welds 30 at block 212 further includes adjusting weld parameters including, but not limited to, location and orientation of a weld gun 24 of a weld assembly 20a-20n associated with the at least one of the plurality of welds 30, a weld schedule for the at least one of the plurality of welds and internal logic algorithms within the weld controller 14.

In another exemplary embodiment, after the automatically adjusting weld parameters for at least one of the plurality of welds 30 at block 212, the method 200 further includes, moving to block 214, collecting, via the weld monitoring system 28, data related to the at least one of the plurality of welds 30 for which adjustments were made, moving to block 216, analyzing, with a plurality of algorithms 48 using deep learning techniques, the data related to the at least one of the plurality of welds 30 for which adjustments were made, and, moving to block 218, determining if the automatic adjustments corrected the identified negative trends.

Wherein, if, at block 218 the system controller 12 determines that the automatic adjustments corrected the identified negative trends, then the method moves to block 220 and ends.

Wherein, if at block 218 the system controller determines that the automatic adjustments did not correct the identified negative trends, the method 200 includes, repeatedly, with the system controller 12, until identified negative trends have been corrected, moving back to block 206, collecting, via the weld monitoring system 28, data related to each one of the plurality of welds 30 on each one of the plurality of vehicle body components 18, moving to block 208, analyzing, with the plurality of algorithms 48 using deep learning techniques, the data related to each one of the plurality of welds 30 on each one of the plurality of vehicle components 18, moving to block 210, identifying, for each of the plurality of welds 30, negative trends associated with occurrence of discrepant welds, and, moving to block 212, automatically, via communication with the weld controller 14, adjusting weld parameters for at least one of the plurality of welds 30.

The system 10 and method 200 of the present disclosure automatically detects negative trends related to discrepant welds, including number of discrepant welds exceeding a pre-determined threshold, number of discrepant welds consistently increasing, and assigned quality measure of identified discrepant welds deteriorating, in order to identify the trend and predict future discrepant welds and pre-emptively adjust weld parameters of welding assemblies to prevent such future discrepant welds.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A system for detecting negative trends in discrepant weld occurrence and automatically adjusting weld parameters, comprising:
a system controller in communication with a weld controller of a manufacturing line for vehicle components, the system controller adapted to:
monitor, with a weld monitoring system in communication with the system controller, a plurality of welds on each one of a plurality of vehicle components as the plurality of vehicle components move along the manufacturing line;
collect, via the weld monitoring system, data related to each one of the plurality of welds on each one of the plurality of vehicle components;
analyze, with a plurality of algorithms using deep learning techniques, the data related to each one of the plurality of welds on each one of the plurality of vehicle components;
identify, for each of the plurality of welds, negative trends associated with occurrence of discrepant welds; and
automatically, via communication with the weld controller, adjust weld parameters for at least one of the plurality of welds.

2. The system of claim 1, wherein, when collecting, via the weld monitoring system, data related to each of the plurality of welds on each one of the plurality of vehicle components, the system controller is further adapted to:
collect, with sensors positioned on welding sub-systems and associated with the weld monitoring system, data related to each of the plurality of welds on each one of the plurality of vehicle components; and
collect, with external sensors associated with the weld monitoring system, data related to each of the plurality of welds on each one of the plurality of vehicle components.

3. The system of claim 2, wherein, when collecting, via the weld monitoring system, data related to each of the plurality of welds on each one of the plurality of vehicle components, the system controller is further adapted to collect data including, but not limited to, weld location, weld schedule and variables associated therewith, a weld identification (ID), vehicle information, and sensor-based inspection data.

4. The system of claim 3, wherein when collecting data including, but not limited to, weld location, weld schedule and variables associated therewith, a weld identification (ID), vehicle information, and sensor-based inspection data, the weld monitoring system is further adapted to communicate with and receive information from at least one of:
a human machine interface (HMI) adapted to allow manual entry of data by a human operator;
a radio frequency identification (RFID) reader adapted to read data from an RFID tag positioned on each one of the vehicle components; and
a vision camera adapted to read data from a two-dimensional matrix positioned on each one of the vehicle components.

5. The system of claim 3, wherein, when collecting, via the weld monitoring system, data related to each of the plurality of welds on each one of the plurality of vehicle components, the system controller is further adapted to collect data for the weld from a database based on the weld ID.

6. The system of claim 5, wherein, when analyzing the data related to each one of the plurality of welds on each one of the plurality of vehicle components, the system controller is further adapted to detect discrepant welds and assign a quality measure for each detected discrepant weld, and match the weld ID and associated weld parameters with computer aided design (CAD) models.

7. The system of claim 6, wherein, when identifying, for each of the plurality of welds, negative trends associated with occurrence of discrepant welds, the system controller is adapted to:
identify the occurrence of, for any one of the plurality of welds, a number of discrepant welds within a sample set that exceeds a pre-determined threshold; and
identify a trend, wherein, for any one of the plurality of welds, a number of discrepant welds within a sample set is increasing; and
identify a trend, wherein, for any one of the plurality of welds, a quality measure of the identified discrepant welds is deteriorating.

8. The system of claim 7, wherein when automatically adjusting weld parameters for at least one of the plurality of welds, the system controller is further adapted to adjust weld parameters including, but not limited to, location and orientation of a weld gun of a weld assembly associated with the at least one of the plurality of welds, a weld schedule for the at least one of the plurality of welds and internal logic algorithms within the weld controller.

9. The system of claim 8, wherein, after automatic adjustments have been made to the weld parameters for at least one of the plurality of welds, the system controller is further adapted to:
collect, via the weld monitoring system, data related to the at least one of the plurality of welds for which adjustments were made;
analyze, with a plurality of algorithms using deep learning techniques, the data related to the at least one of the plurality of welds for which adjustments were made; and
determine if the automatic adjustments corrected the identified negative trends.

10. The system of claim 9, wherein, when the system controller determines that the automatic adjustments did not correct the identified negative trends, the system controller is adapted to repeatedly, until identified negative trends have been corrected:
collect, via the weld monitoring system, data related to each one of the plurality of welds on each one of the plurality of vehicle components;
analyze, with the plurality of algorithms using deep learning techniques, the data related to each one of the plurality of welds on each one of the plurality of vehicle components;
identify, for each of the plurality of welds, negative trends associated with occurrence of discrepant welds; and
automatically, via communication with the weld controller, adjust weld parameters for at least one of the plurality of welds.

11. A method for detecting negative trends in discrepant weld occurrence and automatically adjusting weld parameters, comprising, with a system controller in communication with a weld controller of a manufacturing line for vehicle components:
monitoring, with a weld monitoring system in communication with the system controller, a plurality of welds on each one of a plurality of vehicle components as the plurality of vehicle components move along the manufacturing line;
collecting, via the weld monitoring system, data related to each one of the plurality of welds on each one of the plurality of vehicle components;
analyzing, with a plurality of algorithms using deep learning techniques, the data related to each one of the plurality of welds on each one of the plurality of vehicle components;
identifying, for each of the plurality of welds, negative trends associated with occurrence of discrepant welds; and
automatically, via communication with the weld controller, adjusting weld parameters for at least one of the plurality of welds.

12. The method of claim 11, wherein, the collecting, via the weld monitoring system, data related to each of the plurality of welds on each one of the plurality of vehicle components further includes:
collecting, with sensors positioned on welding sub-systems and associated with the weld monitoring system, data related to each of the plurality of welds on each one of the plurality of vehicle components; and
collecting, with external sensors associated with the weld monitoring system, data related to each of the plurality of welds on each one of the plurality of vehicle components.

13. The method of claim 12, wherein, the collecting, via the weld monitoring system, data related to each of the plurality of welds on each one of the plurality of vehicle components further includes collecting data including, but not limited to, weld location, weld schedule and variables associated therewith, a weld identification (ID), vehicle information, and sensor-based inspection data by at least one of:
communicating and receiving data from a human machine interface (HMI) adapted to allow manual entry of data by a human operator;
communicating and receiving data from a radio frequency identification (RFID) reader adapted to read data from an RFID tag positioned on each one of the vehicle components; and
communicating and receiving data from a vision camera adapted to read data from a two-dimensional matrix positioned on each one of the vehicle components.

14. The method of claim 13, wherein, the collecting, via the weld monitoring system, data related to each of the plurality of welds on each one of the plurality of vehicle components, further includes communicating and receiving data from a database adapted to store information related to the vehicle body components being welded and the plurality of welds to be applied thereon based on the weld ID.

15. The method of claim 14, wherein, the analyzing the data related to each one of the plurality of welds on each one of the plurality of vehicle components further includes:
detecting discrepant welds;
assigning a quality measure for each detected discrepant weld; and
matching the weld ID and associated weld parameters with computer aided design (CAD) models.

16. The method of claim 15, wherein, the identifying, for each of the plurality of welds, negative trends associated with occurrence of discrepant welds further includes:
identifying the occurrence of, for any one of the plurality of welds, a number of discrepant welds within a sample set that exceeds a pre-determined threshold; and
identifying a trend, wherein, for any one of the plurality of welds, a number of discrepant welds within a sample set is increasing; and
identifying a trend, wherein, for any one of the plurality of welds, a quality measure of the identified discrepant welds is deteriorating.

17. The method of claim 16, wherein the automatically adjusting weld parameters for at least one of the plurality of welds further includes adjusting weld parameters including, but not limited to, location and orientation of a weld gun of a weld assembly associated with the at least one of the plurality of welds, a weld schedule for the at least one of the plurality of welds and internal logic algorithms within the weld controller.

18. The method of claim 17, wherein, after automatically adjusting weld parameters for at least one of the plurality of welds, the method further includes:
collecting, via the weld monitoring system, data related to the at least one of the plurality of welds for which adjustments were made;
analyzing, with a plurality of algorithms using deep learning techniques, the data related to the at least one of the plurality of welds for which adjustments were made; and
determining if the automatic adjustments corrected the identified negative trends.

19. The method of claim 18, wherein, when the system controller determines that the automatic adjustments did not correct the identified negative trends, the method includes, repeatedly, with the system controller, until identified negative trends have been corrected:
collecting, via the weld monitoring system, data related to each one of the plurality of welds on each one of the plurality of vehicle body components;
analyzing, with the plurality of algorithms using deep learning techniques, the data related to each one of the plurality of welds on each one of the plurality of vehicle components;
identifying, for each of the plurality of welds, negative trends associated with occurrence of discrepant welds; and
automatically, via communication with the weld controller, adjusting weld parameters for at least one of the plurality of welds.

20. A system for detecting negative trends in discrepant weld occurrence and automatically adjusting weld parameters, comprising:
a system controller in communication with a weld controller of a manufacturing line for vehicle components, the system controller adapted to:
monitor, with a weld monitoring system in communication with the system controller, a plurality of welds on each one of a plurality of vehicle components as the plurality of vehicle components move along the manufacturing line;
collect, with sensors positioned on welding sub-systems and associated with the weld monitoring system and with external sensors associated with the weld monitoring system, data related to each of the plurality of welds on each one of the plurality of vehicle components including, but not limited to, weld location, weld schedule and variables associated therewith, a weld identification (ID), vehicle information, and sensor-based inspection data;
communicate with and receive information, via the weld monitoring system, from at least one of:
a human machine interface (HMI) adapted to allow manual entry of data by a human operator;
a radio frequency identification (RFID) reader adapted to read data from an RFID tag positioned on each one of the vehicle components; or
a vision camera adapted to read data from a two-dimensional matrix positioned on each one of the vehicle components;
analyze, with a plurality of algorithms using deep learning techniques, the data related to each one of the plurality of welds on each one of the plurality of vehicle components and detect discrepant welds and assign a quality measure for each detected discrepant weld, and match the weld ID and associated weld parameters with computer aided design (CAD) models;
identify, for each of the plurality of welds, negative trends associated with occurrence of discrepant welds by identifying the occurrence of, for any one of the plurality of welds, a number of discrepant welds within a sample set that exceeds a pre-determined threshold, and identifying a trend, wherein, for any one of the plurality of welds, a number of discrepant welds within a sample set is increasing;
automatically, via communication with the weld controller, adjust weld parameters for at least one of the plurality of welds, including, but not limited to, location and orientation of a weld gun of a weld assembly associated with the at least one of the plurality of welds, a weld schedule for the at least one of the plurality of welds and internal logic algorithms within the weld controller;
collect, via the weld monitoring system, data related to the at least one of the plurality of welds for which adjustments were made;
analyze, with a plurality of algorithms using deep learning techniques, the data related to the at least one of the plurality of welds for which adjustments were made;
determine if the automatic adjustments corrected the identified negative trends; and
when the system controller determines that the automatic adjustments did not correct the identified negative trends, the system controller is adapted to repeatedly, until identified negative trends have been corrected:
collect, via the weld monitoring system, data related to each one of the plurality of welds on each one of the plurality of vehicle components;
analyze, with the plurality of algorithms using deep learning techniques, the data related to each one of the plurality of welds on each one of the plurality of vehicle components;
identify, for each of the plurality of welds, negative trends associated with occurrence of discrepant welds; and
automatically, via communication with the weld controller, adjust weld parameters for at least one of the plurality of welds.
